(19) United States
(12) Patent Application Publication
(10) Pub. No.: US 2008/0286067 A1
(43) Pub. Date: Nov. 20, 2008

(54) Automobile Body Accessory Fastener

(75) Inventor: Andrew K. Swayne, Dublin, OH (US)

Correspondence Address: KREMBLAS, FOSTER, PHILLIPS & POLLICK, 7632 SLATE RIDGE BOULEVARD, REYNOLDSBURG, OH, 43068, US

(73) Assignee: Honda Motor Co., Ltd.

(21) Appl. No.: 11/748,804

(22) Filed: May 15, 2007

(51) Int. Cl. F16B 37/04; F16B 39/00

(52) U.S. Cl. 411/182

(57) ABSTRACT

A fastener for mounting an automobile body accessory to an automobile body. The fastener includes a doghouse formed in the accessory. The doghouse includes a first wall having a slot formed therein forming two opposing slot faces. A second wall extends transversely from the first wall at an intersection. A bolt includes a shaft and means, such as threads and a nut, at a first shaft end for fastening to the automobile body. A bolt head is formed near an opposite, second shaft end. A washer is mounted to the shaft and spaced from the head to form a recessed collar between the washer and the head. The collar has at least first and second opposing collar faces for disposing adjacent the slot faces. The contact between the faces prevents rotation of the bolt during installation.

### BACKGROUND OF THE INVENTION

1. Field of the Invention

This invention relates to fasteners for attaching an automobile accessory to an automobile body.

2. Description of the Related Art

Automobiles have a structural framework to which decorative and functional body parts, such as spoilers, air deflectors, wings and other accessories, are attached. Some automobiles have a structural framework that is formed from a central frame, and the body parts, such as fenders and doors, are attached to the frame. Other automobiles have a structural framework that is constructed as a “unit body”, in which the body is integrated into a single unit with the chassis rather than having a separate body-on-frame.

Regardless of the type of framework, it is well known to attach an automobile accessory to an automobile body using fasteners, including adhesives, so that the fasteners mount the accessory in the desired position without the fastener being visible. For example, it is common to attach a spoiler using adhesive between the spoiler and the fender or trunk lid, and screws that extend up through the trunk lid into the spoiler. In this example, the screws and adhesive are not able to be viewed from the outside of the automobile.

Some accessories cannot be attached in this manner. For example, some accessories require special fasteners to permit thermal expansion of the accessory. Other accessories must be readily removed for replacement or repair of underlying body components.

As shown in FIGS. 1-3, the prior art bolt 2 and “doghouse” 8 structure have been used to hold a spoiler accessory on a vehicle. The bolt 2 has a shaft 3 and a head 4 at one end of the shaft 3. The washer 5 defines a gap between the washer 5 and the head 4, in which the collar 6 is formed. The sides of the doghouse 8 extend into the collar 6 when the bolt 2 and doghouse 8 are fastened together, as shown in FIG. 3.

In this prior art fastener, the threaded end of the shaft 3 is mounted to the automobile body, and the doghouse, which is part of the accessory spoiler, is brought into registration with the collar 6. The square head 4 seats against the square inside corners of the doghouse, thereby preventing rotation of the bolt 2 relative to the doghouse 8 during installation and tightening of a nut on the bolt 2.

There are problems with the prior art fastener shown in FIGS. 1-3, such as breakage due to stress concentration at sharp corners. The sharp corners are inherent in the design of the prior art fastener due to the need for the square head 4 to contact the walls of the inside corners. This contact prevents rotation of the bolt 2 during installation of the nut on the bolt 2. Therefore, there is a need for an improved fastener for automobile bodies.

### BRIEF SUMMARY OF THE INVENTION

The invention is a fastener for mounting an automobile body accessory to an automobile body. The fastener comprises a doghouse formed in the accessory. The doghouse includes a first wall having a slot formed in the first wall forming two opposing slot faces. A second wall is mounted to the accessory and extends transversely from the first wall at an intersection. A bolt includes a shaft and means, such as threads and a washer and nut, at a first shaft end for fastening to the automobile body. A bolt head is formed near an opposite, second shaft end. A washer is mounted to the shaft and spaced from the head to form a recessed collar between the washer and head. The collar has at least first and second opposing collar faces for disposing adjacent the slot faces.

In a preferred embodiment, the intersection between the first and second sidewalls is curved and has a thickness substantially equal to the first wall and the second wall. The radius of curvature of the curved intersection is contemplated to be between about 1 millimeter and about 10 millimeters. The preferred collar has third and fourth opposing collar faces forming, in combination with the first and second collar faces, a polygon. In a preferred embodiment, the polygon is a rectangle, and in a most preferred embodiment, the polygon is a square.

The head is preferably substantially circular, and the washer is also substantially circular. In a particularly preferred embodiment, a peripheral edge of the circular head extends radially outwardly beyond each of the first, second, third and fourth faces of the collar, and a peripheral edge of the washer extends radially outwardly beyond each of the first, second, third and fourth faces of the collar. The washer is contemplated to be between about 1 millimeter and about 5 millimeters thick.

### BRIEF DESCRIPTION OF THE SEVERAL VIEWS OF THE DRAWINGS

FIG. 1 is a view in perspective illustrating a component of a prior art accessory fastening apparatus.

FIG. 2 is a view in perspective illustrating a component of a prior art accessory fastening apparatus.

FIG. 3 is a view in perspective illustrating the components of the prior art accessory fastening apparatus in a prior art cooperating configuration.

FIG. 4 is a view in perspective illustrating one component of an embodiment of the present invention.

FIG. 5 is a view in perspective illustrating another component of an embodiment of the present invention.

FIG. 6 is a view in perspective illustrating the components of an embodiment of the present invention in a cooperating configuration.

FIG. 7 is a view in section illustrating the component of FIG. 5 viewed through the line 7-7 of FIG. 5.

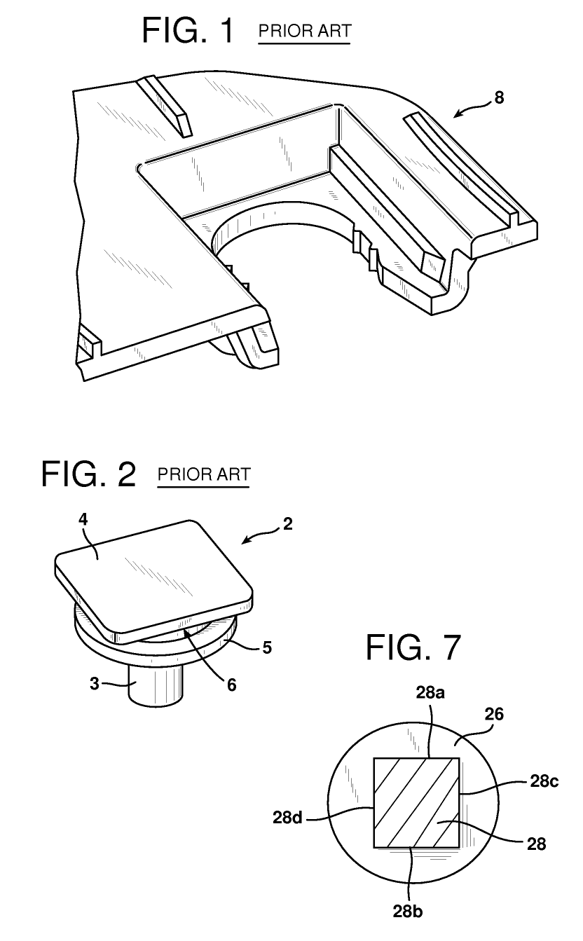

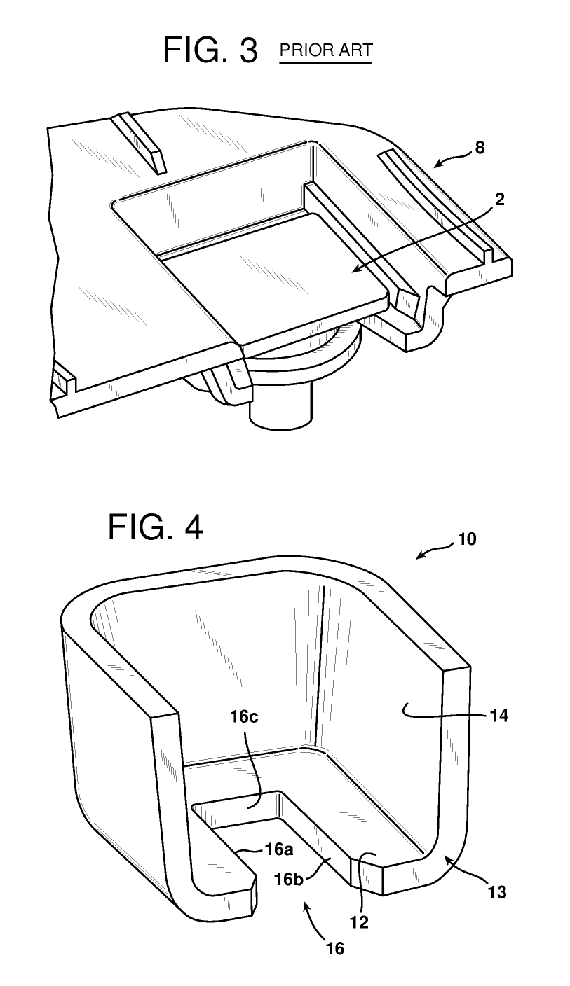

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

The doghouse 10 shown in FIG. 4 has a first sidewall 12 and a second sidewall 14 joined at an intersection 13. The doghouse 10 is a part of an automobile body accessory, such as a spoiler (not shown), that is formed to permit the insertion of a bolt head therein. The sidewall 14 attaches at its upper end (in the orientation shown in FIG. 4) to the automobile body accessory, and in a preferred embodiment is an integral part of the accessory.

The sidewall 14 extends around the lateral edges of the sidewall 12 and attaches to the sidewall 12 along the intersection 13. Preferably, the sidewalls 12 and 14 and the intersection 13 are all formed integrally, such as by injection molding, of a preferably plastic material conventionally used to form automobile body accessories. Of course, the doghouse can be made of other suitable materials, such as aluminum or a composite.

The sidewalls 12 and 14 are transverse to one another. Most preferably, the sidewalls 12 and 14 are substantially perpendicular to one another, but it is contemplated that the sidewalls can form an angle of intersection more or less than about 90 degrees. The intersection 13 is curved, as illustrated, and preferably has a radius between about 1.0 millimeters and about 10 millimeters. The curved intersection 13 has a consistent thickness at the transition from the first sidewall 12 to the second sidewall 14, and no sharp corners are formed. This structure prevents or reduces stresses from concentrating at the intersection 13 by avoiding variations in thickness and avoiding abrupt topographical changes, such as sharp corners or edges. Thus, upon the application of a bending stress to the intersection 13, the intersection 13 bends equally with the sidewall 12 and the sidewall 14. There is no substantial concentration of bending stress due to sharp corners or edges, or due to locally thinner walls.

The sidewall 12 has a slot 16 formed therein that is defined by the opposing, substantially parallel slot faces 16a and 16b, and the slot face 16c that is transverse to the opposing slot faces 16a and 16b. The slot forms a receptive void into which the bolt 20 can be inserted.

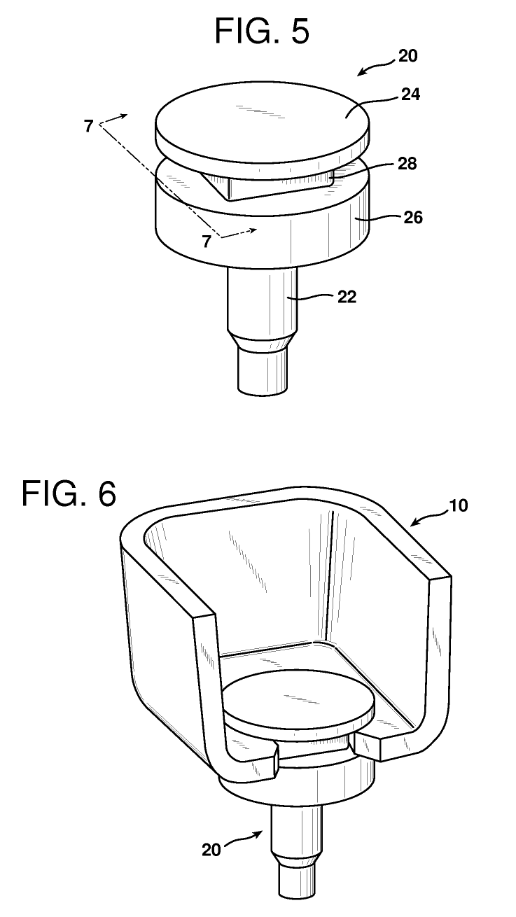

The bolt 20 is shown in FIG. 5 having a central shaft 22 that is preferably threaded at one end, and at or near the opposite end a head 24 is formed thereon. The head 24 is rigidly mounted to the shaft 22 to prevent relative movement of the shaft 22 and the head 24, and preferably the head 24 is formed integrally with the shaft 22. The threaded end is mounted to the automobile body (not shown) in a conventional manner, such as by extending it through an aperture in the automobile's fender and tightening a threaded nut and washer on the threaded end on the opposite side of the fender as the head 24. Of course, the bolt 20 could alternatively be welded, riveted or otherwise attached to the automobile body. The bolt 20 is preferably made of steel, but another material can be substituted, including aluminum or a composite, such as fiber reinforced plastic.

The washer 26 is mounted to the shaft 22 so that it does not move axially along the shaft 22. Although it is preferred that the washer 26 be rigidly mounted to the shaft 22, it is contemplated that the washer 26 can be rotatably mounted to the shaft 22 but not axially displaceable along the shaft 22. The washer 26 is spaced axially from the head 24 a distance that is equal to or greater than the thickness of the sidewall 12 of the doghouse 10, as will be discussed in more detail below. The washer 26 is preferably about 5 millimeters thick, although this thickness can vary, such as between about 1 millimeter and about 5 millimeters. This thickness is preferred so that the washer 26 prevents contact between the doghouse sidewall 12 and the surface of the automobile body against which the washer 26 seats in an operable position.

The collar 28 is a section of the bolt 20 between the head 24 and the washer 26. The collar 28 has at least two substantially oppositely directed faces 28a and 28b (see FIG. 7), is preferably substantially rectangular in cross section, and most preferably is substantially square. The corners at the intersections of the faces 28a, 28d, 28b and 28c are gently rounded in the preferred embodiment to ease installation of the bolt 20 in the doghouse 10. The distance between the faces 28a and 28b is the same as, or, more preferably, slightly less than, the distance between the opposing slot faces 16a and 16b. This permits insertion into the slot 16, but permits the opposing slot faces 16a and 16b to resist rotation of the bolt 20.

When the bolt 20 is inserted in the slot 16 of the doghouse 10, the combination is configured as shown in FIG. 6. In this configuration, the faces 28a and 28b seat against, or are closely adjacent to, the opposing slot faces 16a and 16b. This is due to the distance between the faces 28a and 28b being the same as, or slightly less than, the distance between the slot faces 16a and 16b, as discussed immediately above. The slot faces 16a and 16b of the sidewall 12 are inserted between the head 24 and washer 26 at the collar faces 28a and 28b when the collar 28 is inserted into the slot 16. The slot faces 16a and 16b are locked between the head 24 and washer 26 due to the peripheral edges of the head 24 and the washer 26 extending radially substantially beyond the collar 28, preferably equidistant at all four collar faces, to prevent movement of the sidewall 12 in an axial direction parallel to the shaft 22. The collar 28 can be moved into and out of the slot 16 in a direction parallel to the opposing slot faces 16a and 16b, but the slot faces 16a and 16b prevent rotation of the bolt 20 due to contact with the faces 28a and 28b. Therefore, the bolt 20 is limited to movement into and out of the slot 16 and any substantial rotation or axial movement relative to the doghouse 10 is prevented. In effect, the faces 28a and 28b act in the manner of the faces of a wrench to prevent rotation of the bolt 20 relative to the sidewall 12.

Thermal expansion of the accessory, such as a spoiler, preferably occurs in the direction of the length of the slot 16. This direction is substantially parallel to the opposing slot faces 16a and 16b, which is the only direction in which relative motion is permitted when the bolt 20 is mounted in the doghouse 10 as shown in FIG. 6. Thus, the combination of the doghouse 10 and bolt 20 permits movement in the expansion direction, but prohibits displacement in any other direction.

The head 24 and washer 26 are preferably circular, as illustrated, but this is not critical. These shapes are commonly accepted shapes for manufacturing. The shapes of acceptable alternative heads and washers include, but are not limited to, any polygon (hexagon, pentagon, triangle, etc.) and any uncommon shape, so long as the head and washer function similarly to the preferred head 24 and washer 26 by forming the recessed collar 28 between them. As long as a substantial portion of each of the head and the washer extends beyond the collar, differently-shaped heads and washers will operate to retain the sidewall 12 therebetween. Preferably the head and washer are substantially the same diameter, and extend radially substantially the same distance on all sides of the square collar.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A fastener for mounting an automobile body accessory to an automobile body, the fastener comprising:
(a) a doghouse formed in the accessory, the doghouse including
(i) a second wall mounted to the accessory; and
(ii) a first wall having a slot formed therein forming two opposing slot faces and extending transversely from the second wall at an intersection; and
(b) a bolt including
(i) a shaft;
(ii) means at a first shaft end for fastening to the automobile body;
(iii) a head mounted near an opposite, second shaft end; and
(iv) a washer spaced from the head and mounted to the shaft to form a recessed collar therebetween, wherein the collar has at least first and second opposing collar faces for disposing adjacent the slot faces.

2. The fastener in accordance with claim 1, wherein the intersection is curved and has a thickness substantially equal to the first wall and the second wall.

3. The fastener in accordance with claim 2, wherein a radius of curvature of the curved intersection is between about 1 millimeter and about 10 millimeters.

4. The fastener in accordance with claim 2, wherein the collar has third and fourth opposing collar faces forming, in combination with the first and second collar faces, a polygon.

5. The fastener in accordance with claim 4, wherein the polygon is a rectangle.

6. The fastener in accordance with claim 5, wherein the polygon is a square.

7. The fastener in accordance with claim 6, wherein the head is substantially circular.

8. The fastener in accordance with claim 7, wherein the washer is substantially circular.

9. The fastener in accordance with claim 6, wherein a peripheral edge of the head extends radially outwardly beyond each of the first, second, third and fourth faces of the collar.

10. The fastener in accordance with claim 9, wherein a peripheral edge of the washer extends radially outwardly beyond each of the first, second, third and fourth faces of the collar.

11. The fastener in accordance with claim 10, wherein the washer is between about 1 millimeter and about 5 millimeters thick.
